(19) United States
(12) Patent Application Publication
(10) Pub. No.: US 2026/0124906 A1
(43) Pub. Date: May 7, 2026

(54) ROUGH-TERRAIN VEHICLE

(71) Applicant: KAWASAKI MOTORS, LTD., Hyogo (JP)

(72) Inventors: Kenta TAKADA, Akashi-shi (JP); Kazuma HAMANO, Akashi-shi (JP); Rintaro SHO, Akashi-shi (JP); Takashi HISAMURA, Akashi-shi (JP)

(73) Assignee: KAWASAKI MOTORS, LTD., Hyogo (JP)

(21) Appl. No.: 19/377,613

(22) Filed: Nov. 3, 2025

(30) Foreign Application Priority Data
Nov. 5, 2024 (JP) 2024-193519

(51) Int. Cl. B60K 11/04; B60H 1/22

(52) U.S. Cl. CPC B60K 11/04; B60H 1/22

(57) ABSTRACT

A rough-terrain vehicle includes a passenger compartment in which an occupant is located, a front space in which vehicle-mounted components are housed forwardly of the passenger compartment, a partition wall that partitions the passenger compartment and the front space, a radiator disposed in the front space, a fan, and an air guide that is disposed with clearances rearward of the fan and forward of the partition wall. The fan draws air forward of the radiator and discharges the air rearwardly. The air guide guides fan-exhaust air, which passes through the radiator by the fan, in a direction away from the partition wall outwardly in a vehicle width direction.

### CROSS-REFERENCE TO RELATED APPLICATIONS

The present application claims priority to JP 2024-193519 filed 5 Nov. 2024, of which is incorporated herein by reference.

### TECHNICAL FIELD

The present disclosure relates to a rough-terrain vehicle.

### BACKGROUND ART

Patent Document 1 discloses an off-road vehicle including a cooling tunnel. According to the off-road vehicle disclosed in Patent Document 1, air passing through a radiator and flowing rearwardly of the vehicle flows into the cooling tunnel provided in a lower portion of the vehicle. The cooling tunnel is heated by the air passing through the radiator, whereby a temperature in a passenger compartment located upwardly of the cooling tunnel may increase.

### Patent Document

Patent Document 1: U.S. Pat. No. 8,763,739 B2

### SUMMARY

An object of the present disclosure is to provide a rough-terrain vehicle capable of reducing a temperature rise in a passenger compartment.

The present disclosure provides a rough-terrain vehicle comprising:
a passenger compartment in which an occupant is located;
a front space in which vehicle-mounted components are housed forwardly of the passenger compartment;
a partition wall that partitions the passenger compartment and the front space;
a radiator disposed in the front space;
a fan that, in the front space, draws air forward of the radiator and discharges the air rearwardly; and
an air guide that, in the front space, is disposed with clearances rearward of the fan and forward of the partition wall, and guides fan-exhaust air, which passes through the radiator by the fan, in a direction away from the partition wall outwardly in a vehicle width direction.

According to the rough-terrain vehicle of the present disclosure, the fan-exhaust air is guided by the air guide in the direction away from the partition wall outwardly in the vehicle width direction. As a result, it is possible to reduce a collision of the fan-exhaust air with the partition wall. This makes it possible to reduce a temperature rise in the passenger compartment, due to a temperature rise of the partition wall.

### BRIEF DESCRIPTION OF DRAWINGS

FIG. 1 is a sectional view of a rough-terrain vehicle according to the present embodiment, the sectional view being perpendicular to the up-down direction;

FIG. 2 is a front view of the rough-terrain vehicle according to the present embodiment;

FIG. 3 is a partial front view of the rough-terrain vehicle with some parts omitted from FIG. 2;

FIG. 4 is a sectional view of the rough-terrain vehicle according to the present embodiment, the sectional view being perpendicular to the vehicle width direction;

FIG. 5 is a front view of an air guide according to the present embodiment;

FIG. 6 is a sectional view of the air guide, taken along section VI-VI of FIG. 5;

FIG. 7 is a sectional view of the air guide, taken along section VII-VII of FIG. 5; and

FIG. 8 is a side view of the rough-terrain vehicle according to the present embodiment.

### DETAILED DESCRIPTION

Hereinafter, an embodiment of the present disclosure will be described with reference to the accompanying drawings.

Rough-terrain vehicles are vehicles mainly for off-road traveling not only on a grass field, a gravel field, and a sandy field, but also on an unpaved mountain road or forest road, mud, and rocky ground. Hereinafter, a rough-terrain vehicle 1 is simply referred to as a vehicle 1.

In the present specification, “front”, “rear”, “left”, and “right” refer to a front direction, a rear direction, a left direction, and a right direction as viewed from an occupant in the vehicle 1. A height direction of the vehicle 1 is defined as an up-down direction. The left-right direction corresponds to a direction of a vehicle width of the vehicle 1.

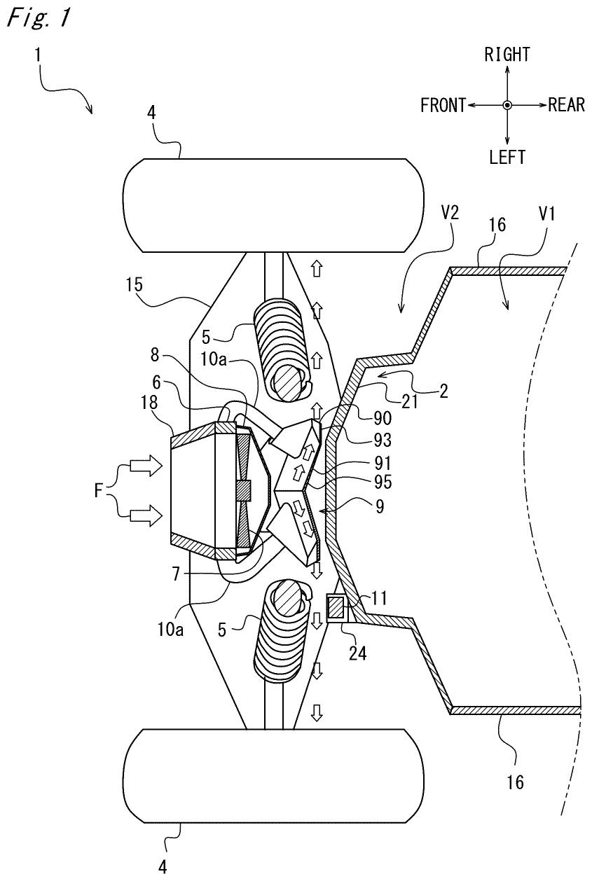

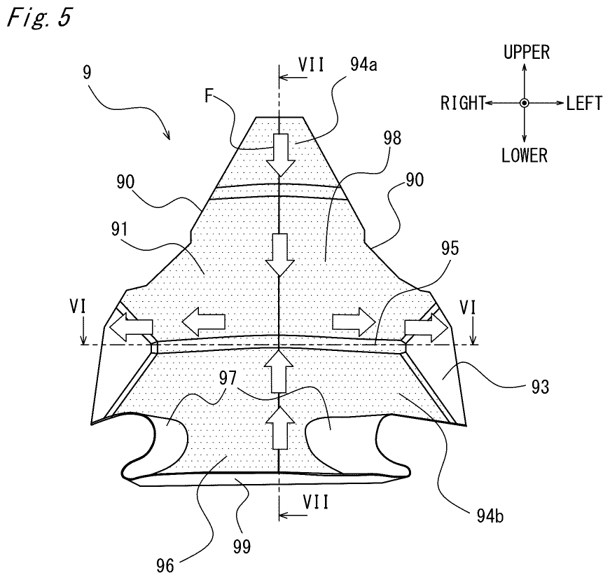

A sectional view of the vehicle 1 illustrated in FIG. 1 is a view of the vehicle 1 cut along a plane perpendicular to the up-down direction, and viewed from above. A height of this section coincides with a height up to an air collecting section 95 (see FIG. 5) of an air guide 9, which will be described later. Note that, in the following drawings, some of the components (headlights, hood, etc.) of the vehicle 1 are omitted.

In the vehicle 1, a passenger compartment V1 in which the occupant gets in, and a front space V2 in which vehicle-mounted components are housed forwardly of the passenger compartment V1, are defined. The passenger compartment V1 is surrounded by a ROPS. The ROPS is an abbreviation for a roll-over protection structure, and is a part of a vehicle body frame 17, which will be described later. The passenger compartment V1 includes a space in which a driver gets in. The passenger compartment V1 is provided with a driver seat, a steering wheel located forwardly of the driver seat, and the like, which are not illustrated.

The vehicle 1 includes a partition wall 2 that partitions the passenger compartment V1 and the front space V2. The front space V2 is a space forward of the partition wall 2 in the vehicle 1. As illustrated in FIG. 1, the partition wall 2 extends in the vehicle width direction, and is connected to two side walls 16 that define ends of the passenger compartment V1 in the vehicle width direction.

The vehicle 1 includes front wheels 4 arranged on the left and right, respectively, arms 15 connected to the respective front wheels 4, and suspensions 5 connected to the arms 15. The front wheels 4, the suspensions 5, and the arms 15 are arranged in the front space V2. The suspensions 5 are a part that absorbs vibration of the vehicle 1. In the present embodiment, in front view, the suspensions 5 extend from an upper end toward a lower side while inclined outwardly in the vehicle width direction. The suspensions 5 are expandable and compressible along their extending directions. An inclination angle of each suspension 5 when the suspension 5 expands is smaller than an inclination angle when the suspension 5 compresses.

The vehicle 1 includes, in the front space V2, a front grille 18, a radiator 6 disposed rearwardly of the front grille 18, a fan 7 disposed rearwardly of the radiator 6, and a fan cover 8 that covers the fan 7. The fan 7, when blades 7a of the fan 7 rotate around a rotating shaft, comes into contact with ambient air and moves forward air rearwardly. The fan cover 8 covers the blades 7a of the fan 7, and has a circular shape in front view. The front grille 18 is exposed to an outside of the vehicle 1. The front grille 18 protects the radiator 6 such that a flying stone or the like does not collide with the radiator 6 disposed rearwardly.

In the present embodiment, the radiator 6 is a heat exchanger for cooling an engine serving as a drive source of the vehicle 1. The shape of the radiator 6 is rectangular in front view. The radiator 6 is connected to coolant pipes 10a for cooling the engine. A coolant for cooling the engine circulates in the radiator 6 and the coolant pipes 10a. The coolant heated by the engine is cooled by heat exchange with air passing through the radiator 6. In other words, the air passing through the radiator 6 is heated by the coolant flowing through the radiator 6.

The fan 7 allows outside air to pass through the radiator 6 to promote the heat exchange by the radiator. Specifically, the fan 7 draws air forward of the radiator 6 and discharges the air rearwardly of the radiator 6. The fan 7 in the present embodiment is actualized with an axial flow fan. The fan 7 moves the air around the blades 7a, by the rotation of the blades 7a, rearwardly in an axial direction that is parallel to the rotating shaft of the blades 7a. Since the fan 7 is the axial flow fan, the flow velocity of the air flowing in a radially outer region about the rotating shaft in the blades 7a is larger than the flow velocity of the air flowing in a radially inner region in the blades 7a.

The fan 7 is disposed adjacently to the radiator 6 in the front-rear direction. More specifically, the fan 7 is disposed inside with respect to outer edges of the radiator 6 in front view. The rotating shaft of the blades 7a of the fan 7 is located at the center position of the radiator 6 in the front-rear direction and the up-down direction. The fan cover 8 is provided with a large number of slits. The air passing through the radiator 6 by the fan 7 (fan-exhaust air) flows rearwardly through the slits of the fan cover 8. Outer portions of the radiator 6 with respect to the fan, the portions being a radially outer side of a rotation region of the blades 7a, may be configured such that air passes rearwardly by oncoming air. Providing the fan 7 makes it possible to reduce a temperature rise of the engine even when the vehicle 1 stops traveling or travels at a reduced speed.

The vehicle 1 further includes the air guide 9 disposed rearwardly of the fan 7. The air guide 9 is disposed with a clearance rearward of the fan 7 and with a clearance forward of the partition wall 2. In other words, the air guide 9 is disposed downstream of the flow direction of the air moved by the fan 7, relative to the radiator. The air guide 9 is disposed between the two suspensions 5 on an inner side in the vehicle width direction. The air guide 9 guides the fan-exhaust air in a desired direction such that the fan-exhaust air moves away from the partition wall 2. Specifically, the air guide 9 deflects, outwardly in the vehicle width direction, the fan-exhaust air flowing toward the rear side. Details and functions of the air guide 9 will be described later.

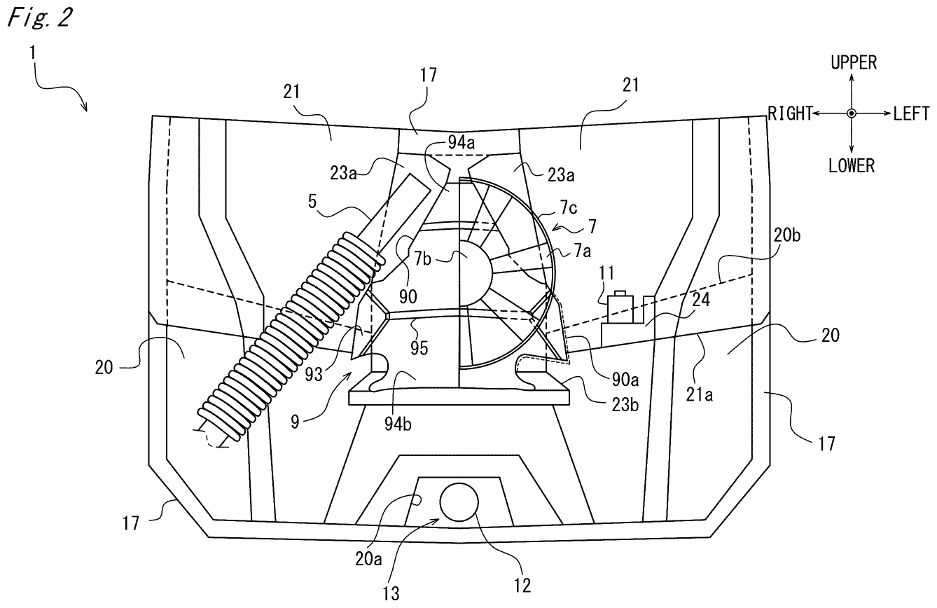

FIG. 2 is a front view of the vehicle 1. In FIG. 2, the front wheels 4, the radiator 6, the fan cover 8, the front grille 18, and the arms 15 are omitted further from FIG. 1. In FIG. 2, the suspension 5 on the right side and the left half of the fan 7 are omitted.

The vehicle 1 includes the vehicle body frame 17 that is a frame of the vehicle 1. Parts, such as the partition wall 2 and the air guide 9, are fixed to the vehicle body frame 17.

The partition wall 2 includes a first wall 20 containing a metal material, and a second wall 21 containing a resin molding material. In FIG. 2, the first wall 20 is located on a lower side of the partition wall 2, and the second wall 21 is located on an upper side of the partition wall 2. In the present embodiment, an upper edge 20b of the first wall 20 and a lower edge 21a of the second wall 21 overlap each other in the front-rear direction. The lower edge 21a of the second wall 21 is located forwardly relative to the upper edge 20b of the first wall 20. Since a lower-side portion of the partition wall 2 is relatively close to the front wheels 4, an obstacle, such as a stone kicked up by the front wheels 4 during driving of the vehicle 1, is likely to collide with the lower-side portion. In the present embodiment, since the lower-side portion, i.e., the first wall having a relatively higher strength than that of the resin material, contains the metal material, damage to the partition wall 2 due to the collision of the obstacle is reduced. Further, when the vehicle 1 travels on an unpaved road, there is a possibility that a protrusion, such as a rock or a fallen tree on a road, in addition to an object kicked up by the wheels, collides with the partition wall 2. In this case as well, since the lower side of the partition wall 2 includes the first wall 20 containing the metal material, it is possible to reduce the likelihood that the protrusion on a road penetrates the partition wall 2.

As illustrated in FIG. 1, the partition wall 2 is inclined rearwardly as going toward an outer side in the vehicle width direction. Specifically, the partition wall 2 is inclined rearwardly, in outer regions in the vehicle width direction relative to opposite ends of the air guide 9 in the vehicle width direction, as going toward the outer side in the vehicle width direction.

The partition wall 2 further includes a plurality of divided bodies 23 at the center of the second wall 21 in the vehicle width direction. In the present embodiment, the partition wall 2 includes a first divided body 23a on the upper side and a second divided body 23b on the lower side. The first divided body 23a and the second divided body 23b contain a resin molding material. The air guide 9 is fixed also to the second divided body 23b. The divided bodies may be divided into the right side and the left side. The divided bodies may also include three or more divided bodies.

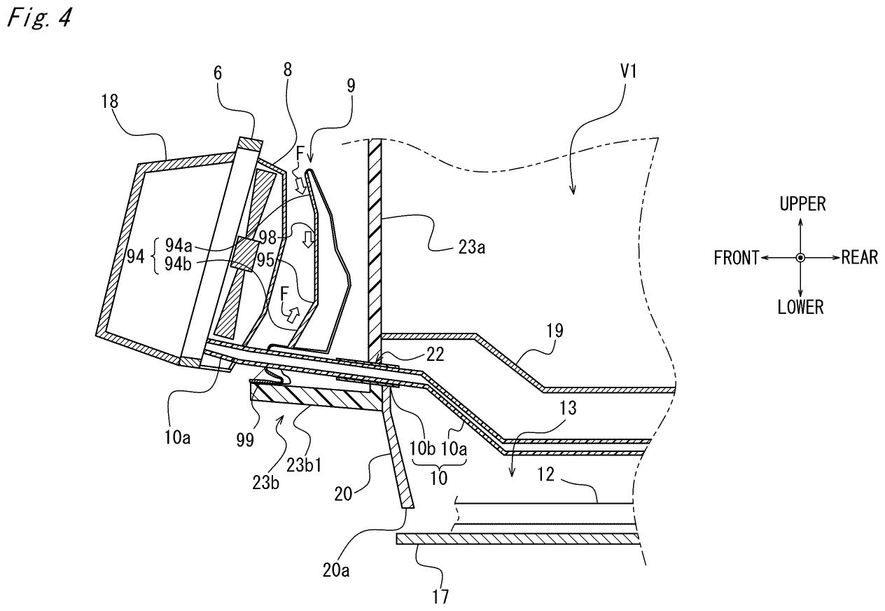

A tunnel opening 20a extending through the first wall 20 in the front-rear direction is provided at the center of the first wall 20 in the vehicle width direction. The tunnel opening 20a communicates with a tunnel 13 (see FIG. 4) in which a propeller shaft 12, the engine, and the like of the vehicle 1 are housed.

As illustrated in FIG. 2, the partition wall 2 includes a support 24 that supports a tank 11 that is one of the vehicle-mounted components. The tank 11 is a resin container that stores a liquid, such as a brake fluid. In the present embodiment, the support 24 is provided on the right side of the partition wall 2, and the tank 11 is disposed on the support 24 and fixed to the support 24. The support 24 is provided in the second portion 21 of the partition wall 2. The air guide 9 is disposed forwardly of the support 24. The support 24 may be provided on the left side of the partition wall 2.

Referring to FIG. 2, the fan 7 includes a hub 7b having a cylindrical shape and including the rotating shaft of the fan 7, a plurality of the blades 7a extending radially from the hub 7b, and an outer frame 7c connecting the plurality of blades 7a to one another at ends of the blades 7a on the radially outer side. Here, a fan diameter refers to a value twice the distance from the center of the hub 7b to the outer frame 7c. In another aspect, when the fan does not include the outer frame, the fan diameter refers to a value twice the distance from the center of the hub 7b to the end of any of the blades 7a on the radially outer side.

The air guide 9 overlaps at least a part of the fan 7 in front view. In the present embodiment, the air guide 9 overlaps the hub 7b of the fan 7 in front view. Further, the air guide 9 overlaps each of an upper end and a lower end of the fan 7 in front view. In the present embodiment, in front view, parts of the fan 7 are located on outer sides in the vehicle width direction relative to the air guide 9. Specifically, ends of the fan 7 on the outer sides in the vehicle width direction are located on the outer sides in the vehicle width direction relative to the air guide 9. More specifically, of the fan 7, portions on the outer sides in the vehicle width direction and an upper side are located on the outer sides in the vehicle width direction relative to the air guide 9.

In the present embodiment, opposite ends 90 of the air guide 9 in the vehicle width direction, i.e., parts of opposite edges in the vehicle width direction are located, at a same height position as the fan 7, on the outer sides in the vehicle width direction relative to opposite ends of the fan 7 in the vehicle width direction. In other words, the air guide 9 includes outer portions 90a (see the smaller dotted line in FIG. 2) located on the outer sides in the vehicle width direction relative to the opposite ends of the fan 7 in the vehicle width direction. In the present embodiment, in a region on lower sides of the air guide 9 and the fan 7, the opposite ends 90 of the air guide 9 are located on the outer sides in the vehicle width direction relative to the opposite ends of the fan 7, i.e., the outer frame 7c. That is, the outer portions 90a of the air guide 9 correspond to lower portions of the opposite ends 90. In another aspect, the outer portions 90a may be provided over the lengths of the opposite ends 90 of the air guide 9 in the up-down direction. Here, “the opposite ends 90 of the air guide 9 are located on the outer sides in the vehicle width direction relative to the opposite ends of the fan 7” also includes that “the opposite ends 90 of the air guide 9 overlap the opposite ends of the fan 7 in front view”.

Further, considering an aspect in which the fan does not include the outer frame, the outer portions 90a of the air guide 9 are located, at a same height position as a virtual circle, on the outer sides in the vehicle width direction relative to opposite ends of the virtual circle in the vehicle width direction, the virtual circle having the fan diameter as its diameter and having the center of the fan diameter as its center. When the centers of the fan 7 and the air guide 9 in the vehicle width direction coincide with each other as in the present embodiment, a maximum width of the air guide 9 in the vehicle width direction is preferably equal to or larger than a maximum width of the fan 7 in the vehicle width direction (i.e., the fan diameter).

As illustrated in FIG. 2, the opposite ends 90 of the air guide 9 in the vehicle width direction extend while inclined outwardly in the vehicle width direction, from the upper end toward the lower side. Further, the opposite ends 90 of the air guide 9 are adjacent to the suspensions 5 in the vehicle width direction in front view. In other words, the opposite ends 90 of the air guide 9 extend along the extending directions of the suspensions 5. More specifically, the opposite ends 90 of the air guide 9 extend along the extending directions when the suspensions 5 expand.

The upper end of the air guide 9 is adjacent to the upper ends of the suspensions 5 in the vehicle width direction in front view. That is, the air guide 9 occupies, to the extent possible, a substantially triangular region defined between the two suspensions 5 in front view.

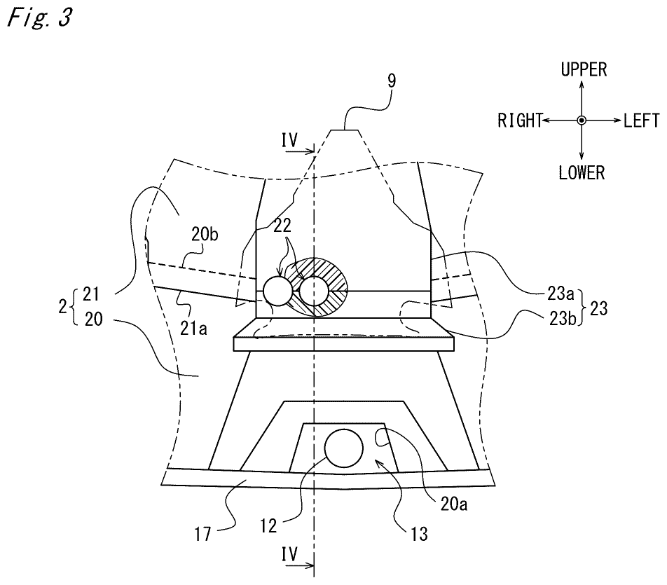

FIG. 3 is a front view of the vehicle 1 partially illustrating surroundings of the divided bodies 23 of the partition wall 2 with the suspensions 5, the fan 7, and the air guide 9 omitted further from FIG. 2. Note that in FIG. 3, the contour of the air guide 9 is drawn as an imaginary line.

The divided body 23 is provided with two through-holes 22 that extend through the partition wall 2, i.e., the divided body 23 in the front-rear direction. The through-holes 22 communicate with the tunnel 13. Coolant pipes 10a, being one of passing objects 10, that extend in the tunnel 13 in the front-rear direction, passes through the through-hole 22. More specifically, the coolant pipe 10a from the engine toward the radiator 6, and the coolant pipe 10a from the radiator 6 toward the engine pass through the through-holes 22, respectively. The air guide 9 is disposed in a region covering at least one of a plurality of the through-holes 22. In the present embodiment, the air guide 9 is disposed at a position covering, from the front, the through-holes 22 through which the coolant pipes 10a pass.

In addition to the illustrated through-holes 22, through-holes through which a steering shaft, harnesses, and the like that are other passing objects 10 pass, are provided. The steering shaft is connected to the steering wheel provided in the passenger compartment V1. The steering shaft extends from the passenger compartment V1 to the front space V2, and passes through a through-hole extending through the partition wall 2. The harnesses are connected to electric parts, such as the fan 7, provided in the front space V2, pass through through-holes extending through the partition wall 2, and extend rearwardly.

FIG. 4 is a sectional view of the vehicle 1, perpendicular to the vehicle width direction. Specifically, FIG. 4 is a sectional view taken along section line IV-IV that passes the center of the through-hole 22 on the right side illustrated in FIG. 3 and extends in the up-down direction. FIG. 4 illustrates the coolant pipe 10a including one end connected to the radiator 6, and passing through the through-hole 22 to extend in the tunnel 13.

The coolant pipes 10a of the present embodiment are rubber hoses. A portion of the coolant pipes 10a passing through the through-holes 22 is covered with a protective cover 10b. The protective cover 10b is, for example, a cylindrical hard rubber member. Covering the coolant pipe 10a by the protective cover 10b reduces the likelihood of the coolant pipe 10a coming into contact with the upper and lower divided bodies 23. This makes it possible to reduce leakage of the coolant in the coolant pipe 10a as a result of damage to the coolant pipe 10a due to the contact with the divided bodies 23. The protective cover 10b is also one of the passing objects 10 because it passes through the through-hole 22.

The first divided body 23a and the second divided body 23b are in direct contact with the protective cover 10b that is the passing object 10, and sandwich the protective cover 10b in the up-down direction. A gap between the protective cover 10b and the two divided bodies 23a and 23b may be omitted.

As illustrated in FIG. 4, the second divided body 23b includes a protrusion 23b1 protruding forwardly. The air guide 9 is fixed to the second divided body 23b by fastening a bottom wall section 99 of the air guide 9 to the protrusion 23b1 of the second divided body 23b with a bolt or the like.

The tunnel 13 is located downwardly of the center of the passenger compartment V1 in the vehicle width direction. The tunnel 13 is partitioned from the passenger compartment V1 by a floor panel 19 that is a bottom surface of the passenger compartment V1. The engine of the vehicle 1 is disposed rearwardly of the tunnel 13. In the tunnel 13, the propeller shaft 12 that drives the front wheels 4 and the rear wheels extends in the front-rear direction.

FIG. 5 is a front view of the air guide 9 according to the present embodiment. The air guide 9 is a plate-like member. The air guide 9 includes vehicle-width inclined sections 91 that are inclined outwardly in the vehicle width direction from a front end toward the rear side. In FIG. 5, a region indicated by dots is the vehicle-width inclined sections 91.

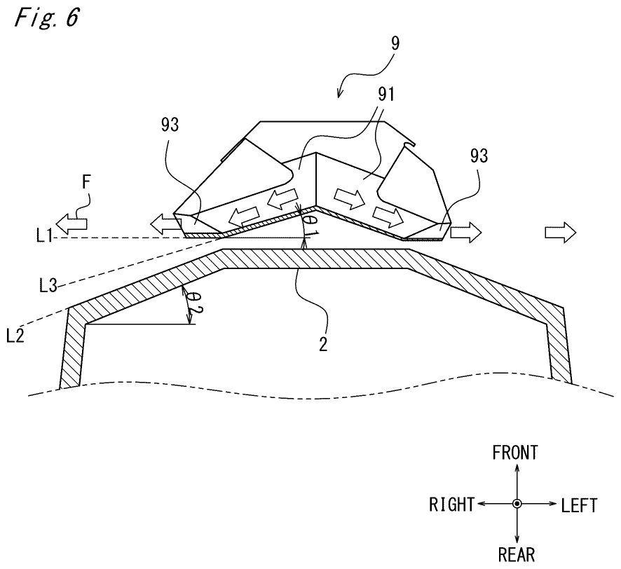

FIG. 6 is a sectional view of the air guide 9 taken along section line VI-VI passing through the air collecting section 95 of the air guide 9, as viewed from above. In FIG. 6, the partition wall 2 is also partially illustrated to indicate a positional relation between the partition wall 2 and the air guide 9. The vehicle-width inclined sections 91 are arranged in a pair on the left and right sides. The left and right vehicle-width inclined sections 91 are arranged on the left and right sides symmetrically to a virtual plane passing through the rotating shaft of the fan 7 and extending in the front-rear direction and the up-down direction. The vehicle-width inclined section 91 on the right side in front view is inclined rightwardly in the vehicle width direction from the front end toward the rear side. Hence, the fan-exhaust air passing on the right side relative to the rotating shaft of the fan 7 is guided rightwardly in the vehicle width direction along the vehicle-width inclined section 91 on the right side. The vehicle-width inclined section 91 on the left side in front view is inclined leftwardly in the vehicle width direction from the front end toward the rear side. Hence, the fan-exhaust air passing on the left side relative to the rotating shaft of the fan 7 is guided leftwardly in the vehicle width direction along the vehicle-width inclined section 91 on the left side. The vehicle-width inclined sections 91 are formed from the upper end up to the lower end of the air guide 9. The vehicle-width inclined sections 91 may be formed in a part of the air guide 9. In a state in which the air guide 9 is installed in the vehicle 1, the vehicle-width inclined sections 91 are preferably inclined rearwardly at an inclination angle θ1 in a range of 15 degrees or more and 75 degrees or less with respect to the vehicle width direction.

The air guide 9 includes turned sections 93 that extend from ends of the vehicle-width inclined sections 91 on the outer sides in the vehicle width direction, in directions inclined forwardly relative to the inclination directions of the vehicle-width inclined sections 91. In the present embodiment, as illustrated in FIG. 6, the turned sections 93 extend in parallel with the vehicle width direction. The turned sections 93 may be inclined outwardly in the vehicle width direction toward the front side. The turned sections 93 may also extend from the ends of the vehicle-width inclined sections 91 on the outer sides in the vehicle width direction, in a direction between the outer sides in the vehicle width direction and the inclination directions of the vehicle-width inclined sections 91. The inclination angle between each of the tuned sections 91 and the vehicle width direction is smaller than an inclination angle θ2 between the vehicle width direction and the partition wall 2. In other words, the dimensions, in the front-rear direction, between an imaginary extension line L1 extending along the turned section 93 in the vehicle width direction, and an imaginary extension line L2 extending along the partition wall 2 in the vehicle width direction, increase as going toward the outer side in the vehicle width direction.

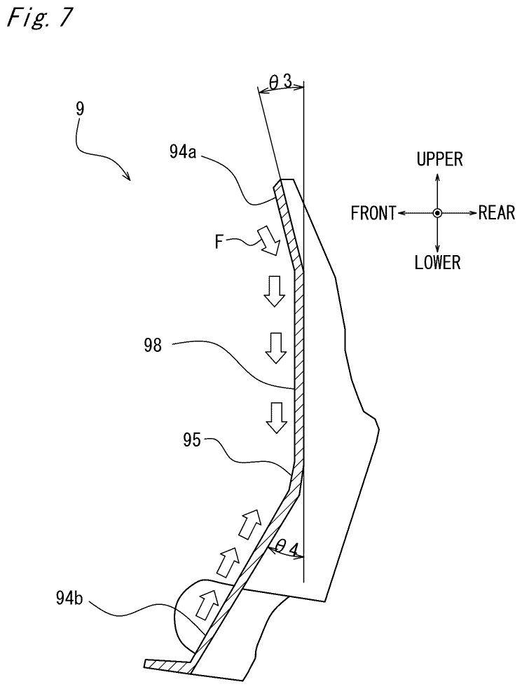

FIG. 7 is a sectional view of the air guide 9 taken along section line VII-VII at the center of the air guide 9 in the vehicle width direction. The air guide 9 includes an upward-downward inclination section 94 that is inclined from the front end toward the rear side in either of the up direction or the down direction. In the present embodiment, the upward-downward inclination section 94 includes a downward inclination section 94a that is inclined downwardly toward the rear side, and an upward inclination section 94b that is inclined upwardly toward the rear side. The downward inclination section 94a is inclined downwardly toward the rear side at an inclination angle θ3. The downward inclination section 94a is provided in an upper half region of the air guide 9. The upward inclination section 94b is inclined upwardly toward the rear side at an inclination angle θ4. The upward inclination section 94b is located downwardly relative to the downward inclination section 94a, and is provided in a lower half region of the air guide 9. In the present embodiment, since the downward inclination section 94a and the upward inclination section 94b are inclined outwardly in the vehicle width direction toward the rear side, they are also regarded as the vehicle-width inclined sections 91. In other words, the downward inclination section 94a is formed in the upper region of the pair of left and right vehicle-width inclined sections 91. The upward inclination section 94b is formed in the lower region of the pair of left and right vehicle-width inclined sections 91.

The air guide 9 further includes the air collecting section 95 located between the downward inclination section 94a and the upward inclination section 94b in the up-down direction. The air collecting section 95 is a portion in which fan-exhaust air guided downwardly by the downward inclination section 94a, and fan-exhaust air guided upwardly by the upward inclination section 94b gather together. In the present embodiment, the air collecting section 95 corresponds to a region along an upper edge of the upward inclination section 94b. That is, the air collecting section 95 is also regarded as the vehicle-width inclined section 91. The air guide 9 may have any one of the downward inclination section 94a and the upward inclination section 94b.

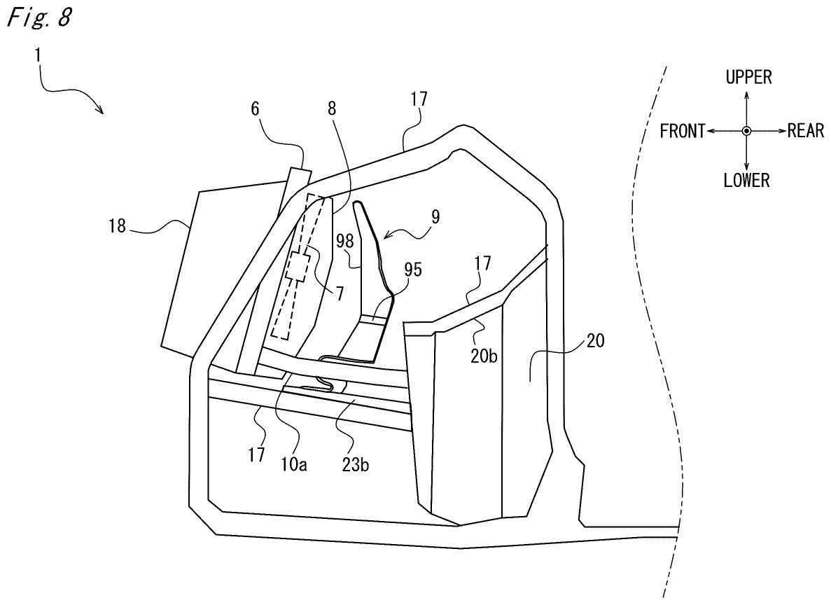

FIG. 8 is a side view of the vehicle 1, in which some parts are omitted. Referring to FIGS. 2 and 8, the air collecting section 95 is located upwardly relative to the upper edge 20b of the first wall 20. “The air collecting section 95 is located upwardly relative to the upper edge 20b of the first wall 20” encompasses that “the air collecting section 95 overlaps the upper edge 20b of the first wall 20 in front view” and that “the air collecting section 95 is located partially upwardly relative to the upper edge 20b of the first wall 20”.

The air guide 9 includes a vertical section 98 that connects the downward inclination section 94a and the air collecting section 95. The vertical section 98 is a plane perpendicular to the horizontal direction (front-rear and left-right directions). The vertical section 98 is also regarded as the vehicle-width inclined section 91 because it is inclined outwardly in the vehicle width direction toward the rear side. In the present embodiment, each of the turned sections 93 is connected to ends of a part of the upward inclination section 94b, the air collecting section 95, and a part of the vertical section 98 on the outer sides in the vehicle width direction. As illustrated in FIGS. 2 and 8, the vertical section 98 is located upwardly relative to the upper edge 20b of the first wall 20.

The air guide 9 further includes pipe avoiding sections 97 for avoiding the coolant pipes 10a. The pipe avoiding sections 97 are convexly curved toward the inner side in the vehicle width direction according to the layout of the coolant pipes 10a. The above-described bottom wall section 99 extends forwardly from lower ends of the upward inclination section 94b and the pipe avoiding sections 97 (see also FIG. 4).

Referring to FIG. 3, the through-holes 22 are shielded from the front by the air guide 9. Specifically, the through-holes 22 are covered with the upward inclination section 94b of the air guide 9. That is, a part of the upward inclination section 94b is a shielding section 96 that covers the through-holes 22 from the front. The shielding section 96 may be located in other areas of the air guide 9, such as in the downward inclination section 94a, the turned sections 93, and the vertical section 98, according to the positions of the through-holes 22.

Next, an air flow in the vehicle 1 according to the present embodiment will be described.

In FIG. 1, an example of the air flow is denoted by reference sign F. The air present forwardly of the radiator 6 is drawn into the radiator 6 by the operation of the fan 7, passes through the radiator 6, the fan 7, and the fan cover 8, and flows backwardly. When passing through the radiator 6, the air is heated by the heat exchange with the coolant pipe 10a in the radiator 6. Hence, the temperature of the air passing through the fan 7 and flowing backwardly, i.e., the fan-exhaust air is higher than the ambient temperature.

When the fan-exhaust air flowing backwardly collides with the partition wall 2, the temperature of the partition wall 2 rises. In a case that the partition wall 2 is made of metal, the thermal conductivity is higher than that in a case that the partition wall 2 is made of a resin molding material, and thus, the temperature readily rises. The temperature rise of the partition wall 2 results in generation of radiant heat from the partition wall 2. In this case, the temperature rise in the passenger compartment V1 present rearwardly of the partition wall 2 is brought about, so that comfort of the passenger compartment V1 may be impaired.

In the present embodiment, the fan-exhaust air passing through the fan 7 collides with the air guide 9 located rearwardly. Specifically, the fan-exhaust air collides with the vehicle-width inclined sections 91 of the air guide 9 and flows outwardly in the vehicle width direction toward the rear side so as to pass along the vehicle-width inclined sections 91. Thereafter, the direction of the flow of the fan-exhaust air is changed to a direction away from the partition wall 2 by the turned sections 93 that extend from the ends of the vehicle-width inclined sections 91 on the outer sides in the vehicle width direction. As a result, the fan-exhaust air moves away from the partition wall 2 outwardly in the vehicle width direction. Thus, the fan-exhaust air is guided by the air guide 9 in a direction away from the partition wall 2 outwardly in the vehicle width direction. This makes it possible to reduce the collision of the fan-exhaust air with the partition wall 2, which can reduce the temperature rise of the partition wall 2, i.e., the temperature rise in the passenger compartment V1.

FIG. 6 illustrates an imaginary extension line L3 extending outwardly in the vehicle width direction along the vehicle-width inclined section 91. Of the imaginary extension line L3, a portion that faces the partition wall 2 in a front-rear direction is located forwardly relative to the partition wall 2. In other words, the imaginary extension line L3 does not intersect the partition wall 2. Hence, the fan-exhaust air flowing along the vehicle-width inclined section 91 is less likely to collide with the partition wall 2.

Further, as illustrated in FIG. 1, the opposite ends 90 of the air guide 9 are located rearwardly relative to the suspensions 5. Hence, the fan-exhaust air flowing outwardly in the vehicle width direction from the opposite ends 90 can flow between the partition wall 2 and the suspensions 5 without being hampered by the suspensions 5.

The air guide 9 guides the fan-exhaust air also in a direction away from the support 24 and the tank 11 outwardly in the vehicle width direction. In the present embodiment, since the air guide 9 is disposed forwardly relative to the support 24, and the turned sections 93 extend outwardly in the vehicle width direction, the fan-exhaust air is less likely to collide with the support 24. Hence, it is possible to reduce the temperature rise of the tank 11.

Referring now to FIGS. 5 and 7, as described above, the fan-exhaust air is guided in the up-down direction by the upward inclination section 94b and the downward inclination section 94a to gather at the air collecting section 95, and is guided outwardly in the vehicle width direction along the air collecting section 95. Since this increases the flow velocity of the fan-exhaust air in the air collecting section 95 relatively, the fan-exhaust air can flow vigorously outwardly in the vehicle width direction. As a result, the flow of the fan-exhaust air can be easily subjected to an inertial force, so that it is possible to reduce the collision of the fan-exhaust air with the partition wall 2 and the support 24 that are located rearwardly. Further, since the turned sections 93 are provided on outer sides of the air collecting section 95 in the vehicle width direction, it is possible to guide more fan-exhaust air in a direction away from the partition wall 2. Also, when the air guide 9 includes any one of the downward inclination section 94a and the upward inclination section 94b, the fan-exhaust air can gather in one of the up and down directions, and flow vigorously outwardly in the vehicle width direction.

As described above, since the air collecting section 95 is located upwardly relative to the upper edge 20b of the first wall 20, a main flow of the fan-exhaust air along the air collecting section 95 can be generated upwardly of the first wall 20. Hence, the fan-exhaust air is even less likely to collide with the first wall 20. As a result, the temperature rise of the first wall 20 having a higher thermal conductivity than that of the resin can be reduced, so that it is possible to further reduce the temperature rise in the passenger compartment V1.

Further, as described above, since the outer portions 90a of the air guide 9 are located, at the same height position as fan 7, on the outer sides in the vehicle width direction relative to the opposite ends of the fan 7, it is possible to guide, by the air guide 9, the fan-exhaust air flow having a width in the vehicle width direction, in a desired direction as much as possible. In particular, since the outer portions 90a are provided in the region on the lower side of the air guide 9, i.e., in the region near the first wall 20, the fan-exhaust air is less likely to collide with the first wall 20. In other words, the fan-exhaust air is guided in a direction away from the second wall 21 and the first wall 20 of the partition wall 2 outwardly in the vehicle width direction, and is guided more in the direction away from the first wall 20.

As described above, since the vertical section 98 is located upwardly relative to the upper edge 20b of the first wall 20, the fan-exhaust air that collides with the vertical section 98 and flows outwardly in the vehicle width direction is also less likely to collide with the first wall 20.

It is preferable that the fan-exhaust air be guided by the air guide 9 in an extensive region in the vehicle width direction and the up-down direction. That is, it is preferable that the area of the air guide 9 in front view be as large as possible. In the present embodiment, in front view, the left and right opposite ends 90 of the air guide 9 extend along the extending directions of the left and right suspensions 5, and the upper end of the air guide 9 is adjacent to the upper ends of the suspensions 5, and thus, it is possible to increase the area of the air guide 9.

Since the thermal conductivity of the second wall 21 containing the resin molding material is lower than the thermal conductivity of the first wall 20, the second wall 21 is less likely to experience a temperature rise as compared with the first wall 20. In the present embodiment, as illustrated in FIG. 2, the support 24 is provided in the second wall 21. Hence, even if the fan-exhaust air partially collides with the second wall 21, the temperature rise of the second wall 21 is relatively small, and thus, the support 24 is less likely to experience a temperature rise. As a result, it is possible to reduce the temperature rise of the liquid in the tank 11, which is one of the vehicle-mounted components, being disposed on the support 24.

When flowing into the tunnel 13, the fan-exhaust air may come into contact with the coolant pipes 10a extending in the tunnel 13 to heat the coolant pipes 10a. This may decrease the cooling effect of the engine and the like. Hence, it is preferable that the fan-exhaust air not flow into the tunnel 13.

As illustrated in FIG. 4, the passing objects 10 pass through the through-holes 22 that communicate with the tunnel 13, and the two divided bodies 23a and 23b sandwich the passing objects 10, and thus, the fan-exhaust air is less likely to flow from the through-holes 22 into the tunnel 13. Further, since the second divided body 23b protrudes forwardly above the tunnel opening 20a communicating with the tunnel 13, the flow of the fan-exhaust air toward the tunnel opening 20a can be hampered by the protrusion 23b1. Hence, the fan-exhaust air is less likely to flow into the tunnel 13 from the tunnel opening 20a. Thus, according to the configuration of the present embodiment, it is possible to reduce the decrease in the cooling effect of the engine and the like due to the fan-exhaust air.

Further, since the air guide 9 includes the shielding section 96, i.e., the air guide 9 covers the through-holes 22 from the front, it is possible to reduce the flow of the fan-exhaust air into gaps between the through-holes 22 and the passing objects 10 passing through the through-holes 22. This makes it possible to reduce entry of hot air into the passenger compartment V1, and to reduce the temperature rise in the passenger compartment V1.

Since, during traveling of the vehicle 1, sufficient oncoming air flows into the front space V2 separately from the air passing through the radiator 6, the temperature rise in the front space V2 is also reduced.

On the other hand, for example, in what is called an idling state in which a vehicle is stationary while the engine is in operation, or in a high-load traveling at a reduced speed in which a vehicle travels on a steep slope at a reduced speed, the flow volume of the oncoming air flowing into the front space V2 is small. In this case, the air passing through the radiator 6 tends to stay in the front space V2 as compared with the traveling state, so that the temperature in the front space V2 readily rises. In the present embodiment, the air guide 9 guides the air passing through the radiator 6 outwardly in the vehicle width direction. In other words, the air guide 9 deflects the air passing through the radiator 6 and guides the air so as to move away from the partition wall 2. This reduces the collision of the air passing through the radiator 6 with the partition wall 2, particularly, the first wall 20 containing a metal material. As a result, it is possible to reduce the radiant heat emitted from the first wall 20 due to the temperature rise of the partition wall 2. This makes it possible to reduce the radiant heat from the partition wall 2 reaching the passenger compartment V1, and to reduce the temperature rise in the passenger compartment V1.

The rough-terrain vehicle 1 according to the present embodiment has the following effects.

(1) A rough-terrain vehicle 1 includes:
a passenger compartment V1 in which an occupant is located;
a front space V2 in which vehicle-mounted components are housed forwardly of the passenger compartment V1;
a partition wall 2 that partitions the passenger compartment V1 and the front space V2;
a radiator 6 disposed in the front space V2;
a fan 7 that, in the front space V2, draws air forward of the radiator 6 and discharges the air rearwardly; and
an air guide 9 that, in the front space V2, is disposed with clearances rearward of the fan 7 and forward of the partition wall 2, and guides fan-exhaust air, which passes through the radiator 6 by the fan 7, in a direction away from the partition wall 2 outwardly in a vehicle width direction.

As a result, it is possible to reduce a collision of the fan-exhaust air with the partition wall 2, and to reduce a temperature rise of the partition wall 2, i.e., a temperature rise in the passenger compartment V1.

(2) The partition wall 2 includes a first wall 20 containing a metal material, and
the air guide 9 guides the fan-exhaust air in a direction away from the first wall 20 outwardly in the vehicle width direction.

As a result, it is possible to reduce a temperature rise of the first wall 20 having a higher thermal conductivity than that of a resin, so that it is possible to further reduce the temperature rise in the passenger compartment V1.

(3) The air guide 9 includes
outer portions 90a located, at a same height position as a virtual circle, on outer sides in the vehicle width direction relative to opposite ends of the virtual circle in the vehicle width direction, the virtual circle having a fan diameter of the fan 7 as its diameter and having a center of the fan diameter as its center.

As a result, an fan-exhaust air flow having a width in the vehicle width direction can be guided by the air guide 9 in a desired direction.

(4) The air guide 9 includes a vehicle-width inclined section 91 that is inclined outwardly in the vehicle width direction toward a rear side.

As a result, the fan-exhaust air is guided along the vehicle-width inclined section 91, and thus, it is possible to reduce the collision of the fan-exhaust air with the partition wall 2.

(5) Of an imaginary extension line L3 extending outwardly in the vehicle width direction along the vehicle-width inclined section 91, a portion that faces the partition wall 2 in a front-rear direction is located forwardly relative to the partition wall 2.

As a result, the fan-exhaust air flowing along the vehicle-width inclined section 91 is less likely to collide with the partition wall 2.

(6) The air guide 9 includes a turned section 93 that extends in a direction inclined forwardly relative to an inclination direction of the vehicle-width inclined section 91 from an end of the vehicle-width inclined section 91 on an outer side in the vehicle width direction.

As a result, the fan-exhaust air flows along the turned section 93, and thus, it is possible to further reduce the collision of the fan-exhaust air with the partition wall 2.

(7) The air guide 9 includes an upward-downward inclination section 94 that is inclined toward a rear side in either of an up direction or a down direction.

The fan-exhaust air is guided upwardly or downwardly by the upward-downward inclination section 94, whereby it is possible to intensively guide the fan-exhaust air outwardly in the vehicle width direction. As a result, the fan-exhaust air flows vigorously outwardly in the vehicle width direction, and thus, it is possible to reduce the collision with the partition wall 2.

(8) The air guide 9 includes a downward inclination section 94a that is inclined downwardly toward a rear side; an upward inclination section 94b that is located downwardly relative to the downward inclination section 94a, and is inclined upwardly toward the rear side; and an air collecting section 95 that is located between the downward inclination section 94a and the upward inclination section 94b in an up-down direction.

As a result, the fan-exhaust air is guided in the up-down direction by the upward inclination section 94b and the downward inclination section 94a to gather at the air collecting section 95, and is guided along the air collecting section 95. Since this allows the fan-exhaust air to be guided further vigorously outwardly in the vehicle width direction, it is possible to further reduce the collision with the partition wall 2.

(9) The air guide 9 includes a turned section 93 that is inclined forwardly relative to an extending direction of the air collecting section 95 from an end of the air collecting section 95 on an outer side in the vehicle width direction.

As a result, it is possible to guide more fan-exhaust air in a direction away from the partition wall 2.

(10) The partition wall 2 includes a first wall 20 containing a metal material, and
the air collecting section 95 is located upwardly relative to an upper edge 20b of the first wall 20.

As a result, the collision with the first wall 20 by the fan-exhaust air is reduced, so that it is possible to further reduce the temperature rise in the passenger compartment V1.

(11) Opposite ends 90 of the air guide 9 in the vehicle width direction are located rearwardly relative to suspensions 5 connected to front wheels 4 of the rough-terrain vehicle 1.

As a result, the fan-exhaust air flowing outwardly in the vehicle width direction from the opposite ends 90 can flow in a desired direction without being hampered by the suspensions 5.

(12) Opposite ends 90 of the air guide 9 in the vehicle width direction extend along suspensions 5 connected to front wheels 4 of the rough-terrain vehicle 1.

As a result, it is possible to increase the area of the air guide 9 in front view, so that the fan-exhaust air can be guided by the air guide 9 in an extensive region in the vehicle width direction and the up-down direction.

(13) The partition wall 2 is provided with a through-hole 22 that extends through the partition wall 2 in a front-rear direction, and
the air guide 9 includes a shielding section 96 that covers the through-hole 22 from a front.

As a result, it is possible to reduce the flow of the fan-exhaust air toward the through-hole 22, and thus, it is possible to reduce the flow of the fan-exhaust air into a tunnel 13 communicating with the through-hole 22. This makes it possible to reduce the likelihood that a coolant pipe 10a extending in the tunnel 13 may be heated by the fan-exhaust air. Further, the temperature rise in the passenger compartment V1 through the tunnel 13 can also be reduced.

(14) The partition wall 2 includes a plurality of divided bodies 23, and
the plurality of divided bodies 23 are in direct contact with a passing object 10 passing through the through-hole 22, and sandwich the passing object 10.

As a result, the fan-exhaust air is less likely to flow into the tunnel 13 through the through-hole 22.

(15) The partition wall 2 includes a support 24 that supports a tank 11 storing a liquid, and
the air guide 9 is disposed on an inner side in the vehicle width direction relative to the support 24, and guides the fan-exhaust air in a direction away from the support 24 outwardly in the vehicle width direction.

As a result, the fan-exhaust air is less likely to collide with the support 24. This makes it possible to reduce a temperature rise of the tank 11, which can reduce a deterioration of the liquid in the tank 11.

(16) The partition wall 2 includes a first wall 20 containing a metal material, and a second wall 21 containing a resin molding material, and
the second wall 21 includes a support 24 that supports at least one of the vehicle-mounted components.

As a result, the support 24 is provided in the second wall 21 in which the temperature is less likely to rise relatively, and thus, it is possible to reduce the temperature rise of the liquid in the tank 11, which is one of the vehicle-mounted components, being disposed on the support 24.

(17) A rough-terrain vehicle 1 includes:
a passenger compartment V1 in which an occupant is located;
a front space V2 in which vehicle-mounted components are housed forwardly of the passenger compartment V1;
a partition wall 2 that partitions the passenger compartment V1 and the front space V2,
   wherein the partition wall 2 includes a first wall 20 containing a metal material, and a second wall 21 containing a resin molding material, and
   wherein the second wall 21 includes a support 24 that supports at least one of the vehicle-mounted components;
a radiator 6 disposed in the front space V2; and
a fan 7 that, in the front space V2, draws air forward of the radiator 6 and discharges the air rearwardly.

As a result, the support 24 is provided in the second wall 21 in which a temperature is less likely to rise relatively, and thus, it is possible to reduce a temperature rise of a liquid in a tank 11, which is one of the vehicle-mounted components, being disposed on the support 24.

(18) A rough-terrain vehicle 1 includes:
a passenger compartment V1 in which an occupant is located;
a front space V2 in which vehicle-mounted components are housed forwardly of the passenger compartment V1;
a partition wall 2 that partitions the passenger compartment V1 and the front space V2,
   wherein the partition wall 2 is provided with a through-hole 22 that extends through the partition wall 2 in a front-rear direction,
   wherein the partition wall 2 includes a plurality of divided bodies 23, and
   wherein the plurality of divided bodies 23 are in direct contact with a passing object 10 passing through the through-hole 22, and sandwich the passing object 10;
a radiator 6 disposed in the front space V2; and
a fan 7 that, in the front space V2, draws air forward of the radiator 6 and discharges the air rearwardly.

As a result, the fan-exhaust air is less likely to flow into a tunnel 13 through the through-hole 22, and thus, it is possible to reduce the likelihood that a coolant pipe 10a extending in the tunnel 13 may be heated by the fan-exhaust air.

Note that the rough-terrain vehicle 1 according to the present disclosure is not limited to the configuration of the above embodiment, and various modifications can be made.

The air guide 9 may not include the turned section 93. In such an aspect as well, the fan-exhaust air can be guided in a direction away from the partition wall 2 outwardly in the vehicle width direction.

The divided bodies 23 may be brought into direct contact with the coolant pipe 10a, and sandwich the coolant pipe 10a. That is, the protective cover 10b may not be provided.

A fan shroud in which the fan 7 may be housed and which streamlines the airflow, may be provided rearwardly of the radiator 6. Using both the fan shroud and the air guide 9 allows the fan-exhaust air to be inhibited more reliably from directing toward the partition wall 2.

The slits provided in the fan cover 8 may be inclined so that the fan-exhaust air may be directed outwardly in the vehicle width direction as the fan-exhaust air moves rearwardly. This makes it possible to more reliably reduce the likelihood that the fan-exhaust air is directed toward the partition wall 2.

The opposite ends 90 of the air guide 9 may be located, at the same height position as the fan 7, on the inner sides in the vehicle width direction relative to the opposite ends of the fan 7 in the vehicle width direction. In this aspect as well, it is possible to reduce the likelihood that the fan-exhaust air is directed toward the partition wall 2. The air guide 9 may be formed so as to overlap the entire fan 7 in front view.

The air guide 9 may not include the vertical section 98. That is, the downward inclination section 94a may be directly connected to the air collecting section 95. In this case, the air collecting section 95 includes a boundary line between the upward inclination section 94b and the downward inclination section 94a. This boundary line is located downwardly relative to the rotating shaft of the fan 7. Further, the boundary line is located downwardly relative to the center position of the air guide 9 in the up-down direction. The boundary line is inclined rearwardly as going toward the outer sides in the vehicle width direction from the center position of the boundary line in the vehicle width direction. The turned sections 93 are located on outer sides of the boundary line in the vehicle width direction. The fan-exhaust air colliding with the upward inclination section 94b and the downward inclination section 94a is guided toward the boundary line. The fan-exhaust air guided to the boundary line is guided rearwardly as going outwardly in the vehicle width direction along the boundary line. Since the turned sections 93 are arranged on the outer sides in the vehicle width direction relative to the boundary line, the fan-exhaust air guided along the boundary line is guided in a direction away from the partition wall 2 by the turned sections 93.

The suspensions 5 may be arranged so as not to overlap the air guide 9 in front view.

The fan 7 may be disposed forwardly of the radiator 6.

The radiator 6 may cool a refrigerant for cooling an object other than the engine. For example, when supercharged air leads to the engine, the radiator 6 may cool a refrigerant for cooling the supercharged air. When the drive source is an electric motor, the radiator 6 may cool a refrigerant for cooling the motor itself or a battery of the motor. The radiator 6 may cool a refrigerant for an air conditioner.

The fan cover 8 may not be provided.

The fan may be a fan other than the axial flow fan. For example, the fan may be a centrifugal fan. When the fan is the axial flow fan, the air guide 9 of the present disclosure can guide the fan-exhaust air appropriately in a desired direction.

What is claimed is

1. A rough-terrain vehicle comprising:
a passenger compartment in which an occupant is located;
a front space in which vehicle-mounted components are housed forwardly of the passenger compartment;
a partition wall that partitions the passenger compartment and the front space;
a radiator disposed in the front space;
a fan that, in the front space, draws air forward of the radiator and discharges the air rearwardly; and
an air guide that, in the front space, is disposed with clearances rearward of the fan and forward of the partition wall, and guides fan-exhaust air, which passes through the radiator by the fan, in a direction away from the partition wall outwardly in a vehicle width direction.

2. The rough-terrain vehicle according to claim 1, wherein
the partition wall includes a first wall containing a metal material, and
the air guide guides the fan-exhaust air in a direction away from the first wall outwardly in the vehicle width direction.

3. The rough-terrain vehicle according to claim 1, wherein
the air guide includes outer portions located, at a same height position as a virtual circle, on outer sides in the vehicle width direction relative to opposite ends of the virtual circle in the vehicle width direction, the virtual circle having a fan diameter of the fan as a diameter and having a center of the fan diameter as a center.

4. The rough-terrain vehicle according to claim 1, wherein the air guide includes a vehicle-width inclined section that is inclined outwardly in the vehicle width direction toward a rear side.

5. The rough-terrain vehicle according to claim 4, wherein, of an imaginary extension line extending outwardly in the vehicle width direction along the vehicle-width inclined section, a portion that faces the partition wall in a front-rear direction is located forwardly relative to the partition wall.

6. The rough-terrain vehicle according to claim 4, wherein the air guide includes a turned section that extends in a direction inclined forwardly relative to an inclination direction of the vehicle-width inclined section from an end of the vehicle-width inclined section on an outer side in the vehicle width direction.

7. The rough-terrain vehicle according to claim 1, wherein the air guide includes an upward-downward inclination section that is inclined toward a rear side in either of an up direction or a down direction.

8. The rough-terrain vehicle according to claim 1, wherein the air guide includes a downward inclination section that is inclined downwardly toward a rear side; an upward inclination section that is located downwardly relative to the downward inclination section, and is inclined upwardly toward the rear side; and an air collecting section that is located between the downward inclination section and the upward inclination section in an up-down direction.

9. The rough-terrain vehicle according to claim 8, wherein the air guide includes a turned section that is inclined forwardly relative to an extending direction of the air collecting section from an end of the air collecting section on an outer side in the vehicle width direction.

10. The rough-terrain vehicle according to claim 8, wherein
the partition wall includes a first wall containing a metal material, and
the air collecting section is located upwardly relative to an upper edge of the first wall.

11. The rough-terrain vehicle according to claim 1, wherein opposite ends of the air guide in the vehicle width direction are located rearwardly relative to suspensions connected to front wheels of the rough-terrain vehicle.

12. The rough-terrain vehicle according to claim 1, wherein opposite ends of the air guide in the vehicle width direction extend along suspensions connected to front wheels of the rough-terrain vehicle.

13. The rough-terrain vehicle according to claim 1, wherein
the partition wall is provided with a through-hole that extends through the partition wall in a front-rear direction, and
the air guide includes a shielding section that covers the through-hole from a front.

14. The rough-terrain vehicle according to claim 13, wherein
the partition wall includes a plurality of divided bodies, and
the plurality of divided bodies are in direct contact with a passing object passing through the through-hole, and sandwich the passing object.

15. The rough-terrain vehicle according to claim 1, wherein
the partition wall includes a support that supports a tank storing a liquid, and
the air guide is disposed on an inner side in the vehicle width direction relative to the support, and guides the fan-exhaust air in a direction away from the support outwardly in the vehicle width direction.

16. The rough-terrain vehicle according to claim 1, wherein
the partition wall includes a first wall containing a metal material, and a second wall containing a resin molding material, and
the second wall includes a support that supports at least one of the vehicle-mounted components.

17. A rough-terrain vehicle comprising:
a passenger compartment in which an occupant is located;
a front space in which vehicle-mounted components are housed forwardly of the passenger compartment;
a partition wall that partitions the passenger compartment and the front space,
wherein the partition wall includes a first wall containing a metal material, and a second wall containing a resin molding material, and
wherein the second wall includes a support that supports at least one of the vehicle-mounted components;
a radiator disposed in the front space; and
a fan that, in the front space, draws air forward of the radiator and discharges the air rearwardly.

18. A rough-terrain vehicle comprising:
a passenger compartment in which an occupant is located;
a front space in which vehicle-mounted components are housed forwardly of the passenger compartment;
a partition wall that partitions the passenger compartment and the front space,
wherein the partition wall is provided with a through-hole that extends through the partition wall in a front-rear direction,
wherein the partition wall includes a plurality of divided bodies, and
wherein the plurality of divided bodies are in direct contact with a passing object passing through the through-hole, and sandwich the passing object;
a radiator disposed in the front space; and
a fan that, in the front space, draws air forward of the radiator and discharges the air rearwardly.
